(19) United States
(12) Patent Application Publication
(10) Pub. No.: US 2002/0153309 A1
(43) Pub. Date: Oct. 24, 2002

(54) Process for treating liquid streams to remove unwanted impurities

(76) Inventor: Robert L. Irvine, Overland Park, KS (US)

Correspondence Address: Attn: William A. Rudy, LATHROP & GAGE, L.C., Suite 2800, 2345 Grand Boulevard, Kansas City, MO, 64108, US

(21) Appl. No.: 10/057,180

(22) Filed: Jan. 25, 2002

Related U.S. Application Data
(63) Continuation-in-part of application No. 09/934,759, filed on Aug. 22, 2001.
(60) Provisional application No. 60/226,962, filed on Aug. 22, 2000.

(51) Int. Cl. B01D 11/00; C02F 1/42; C02F 1/44

(52) U.S. Cl. 210/634; 210/639; 210/670; 210/676; 210/677; 210/774

(57) ABSTRACT

A continuous adsorption facility is used to purify a liquid stream that contains impurities. A solid adsorbent is used having a special affinity for the impurities over the desired components in the liquid feed. An adsorber is constructed, employing gravity for the transfer of adsorbent between stages with a series of stages each having fluidized beds with limited bed expansion characteristics where the solid adsorbent countercurrent- contacts the upwardly flowing fresh feed introduced at the base. The adsorbent is regenerated with return of most of the desired components from the porous solids becoming part of the adsorber-treated product. Impurities are further removed during regeneration and disposed of separately. Using a novel regeneration arrangement, the reactivating gas may be reduced to below 5% of prior requirements. Capital investment and operating costs economically afford ultra-low sulfur clean gasoline meeting standards imposed by auto manufacturers worldwide.

### RELATED APPLICATIONS

This application claims benefit of priority to U.S. patent application Ser. No. 09/934,759 filed on Aug. 22, 2001, which is the nonprovisional application of 60/226,962 filed on Aug. 22, 2000 hereby incorporated by reference to the same extent as though fully disclosed herein.

### FIELD OF THE INVENTION

This invention pertains to method and apparatus for treating liquids that contain unwanted impurities for which a selective adsorbent has affinity over desired components. More specifically, the impurity-bound adsorbent may be regenerated and recycled for additional use in removing the impurities.

### DESCRIPTION OF THE PRIOR ART

An immediate requirement concerns the purification of liquid streams to remove impurities down to levels that have heretofore not been required on a large scale production basis. For example, there is an urgent need to reduce the sulfur content of liquid gasoline to lower levels of about 5 ppm by weight, which automobile manufacturers require to meet increasingly stringent environmental regulations.

It is a problem in the art that existing technologies cannot acceptably reduce the sulfur content of the olefinic compounds of gasoline. In particular, fluid catalytic cracker (FCC) gasoline generally account for approximately 40% of the U.S. gasoline refinery production while coker-produced light gasoline constitutes approximately 4% of the U.S. gasoline production from the West Coast and Gulf Coast refineries. Prior technologies include hydrotreating processes, caustic extraction processes, and bed adsorption processes. In combination, these streams account for more than 90% of the sulfur content in the gasoline stream. Traditional methods for sulfur removal from fluid catalytic cracker (FCC) feedstocks include hydrotreating, caustic extraction, and unsteady state/fixed bed adsorption.

Hydrotreating of FCC feedstocks may lower the sulfur content in refined petroleum products, such as gasoline, but yield benefits are marginal after reducing the nitrogen heteroatom content below approximately 600 ppm by weight.

At present, only about one-third of FCC feedstocks are hydrotreated. Hydro-treating processes remove most of the sulfur components from a hydrocarbon feedstream by reacting the sulfur components with hydrogen gas in the presence of a suitable catalyst to form hydrogen sulfide. Hydrogen sulfide is removed from the product gas stream using an amine wash solvent followed by conversion of the hydrogen sulfide to elemental sulfur in a Claus plant. The hydrotreating process scheme usually involves mixing of a hydrocarbon feedstream with a hydrogen-rich gas and, thereafter, heating and passing the hydrocarbon/gas mixture through a catalyst bed in a reactor. The reactor product is cooled and separated into a gas and liquid phase. Hydrogen sulfide in the off-gas is usually removed and converted to sulfur.

Gasoline feed hydrotreating facilities, even those using selective catalyst to better preserve the octane quality, have heightened capital cost, have relatively high utility consumption, require fixed heaters and have higher hydrogen consumptions.

Caustic extraction processes, such as those using mercaptan oxidation (merox) processes, or those offered by Merichem of Houston, Tex., are capable of extracting sulfur from hydrocarbon in the form of mercaptan compounds. Mercaptans are corrosive compounds, which must be extracted or converted to meet a copper strip test. Sodium mercaptides are typically formed and dissolved in a caustic solution, which warmed and then oxidized with air with a catalyst in a mixer column to converts the mercaptides to disulfides. For lower carbon number mercaptans, disulfides are only soluble to a limited extent. Caustic is recycled for mercaptan extraction. Caustic treated hydrocarbon is usually washed with water to reduce the sodium content in the treated product. Caustic extraction processes, however, primarily extract sulfur only in the form of mercaptan compounds with extraction capability decreasing with carbon number. Mercaptan compounds account for less than 8% of the sulfur that is present in a FCC gasoline.

Caustic extraction problems include: generation of such hazardous liquid waste streams as spent caustic; smelly gas streams arising from the fouled air effluent resulting from the oxidation step; and the disposal of the disulfide stream. Further, merox processing problems include difficulties associated with handling of a sodium and water contaminated product. Caustic extraction is usually able to remove lighter boiling mercaptans while other sulfur components, such as sulfides and thiophenes, remain in the treated product streams. Accordingly, some disulfides are introduced into the caustic-treated product, typically, when the caustic from the oxidation step is directly recycled for mercaptan extraction. Caustic extraction processes suffer decreasing amounts of extraction for each carbon atom that is added to the mercaptan compound. Caustic extraction processes do not appreciably extract sulfur compounds other than mercaptans; the nitrogen compounds, such as nitrites; or the oxygen compounds, such as peroxides; all of which remain in the feedstocks to create downstream problems.

Unsteady state/fixed bed adsorbers have also, in the past, been used as a means to remove a portion of pollutants when batch adsorption is permitted. The process scheme calls for a hydrocarbon stream containing a pollutant to be passed down through the relatively deep bed of adsorbent, which is initially free of the pollutant to be adsorbed. The top layer of adsorbent contacts the contaminated hydrocarbon entering the stream and is the first portion to adsorb the pollutants. The adsorbent will becomes progressively saturated with pollutant causing a breakthrough of the pollutant at the outlet of the adsorber vessel from which a product stream is issuing. Accordingly, the pollutant-saturated adsorbent bed must be cycled off line and regenerated by raising the temperature of the adsorbent to a level causing a release of the pollutant from the adsorbent. The temperatures of the adsorbent, including vessels and internals including the adsorbent, are raised usually by means of passing a hot gas reactivating medium through the adsorbent bed. This gas also carries the released pollutants from the adsorbent bed. Following regeneration, the adsorbent and vessel are cooled and cycled back on line. Problems arise, however, because the stream carrying the pollutants must be disposed of in an environmentally safe manner. The batch cycling process subjects the equipment, utilities, and the adsorbent, to cyclic heating and cooling, and thereby increases the quantity of both the adsorbent and reactivating medium required for the process. Furthermore, a significant portion of the adsorbent, when regenerated, under the batch process contains low levels of deposited heteroatoms.

U.S. Pat. No. 5,730,860, entitled Process for Desulfurizing Gasoline and Hydrocarbon Feedstocks, which is incorporated by reference to the same extent as though fully replicated herein, describes a method and apparatus for continuously removing impurities from a hydrocarbon stream through use of a selective particulate adsorbent that is subsequently regenerated and recycled. The process described therein has several disadvantages, particularly, with the continuing evolution of requirements for ever more stringent low sulfur levels. The process requires a significant amount of the catalytic reformer hydrogen output for use as a reactivating gas in the regenerator section. Although the hydrogen is recovered in downstream units, a number of potential refiners have determined that supplying such a large quantity of gas could be a major concern. Further, processing the entire stream of impurity byproduct liquid, which contains predominantly heteroatom compounds, has disadvantages in the context of processing this liquid as part of an existing higher pressure unit. Such processing usually downgrades a potential high octane stream to a lower grade catalytic reformer feedstock and increases the olefin concentration, hence, requiring saturation of the resultant olefins with additional hydrogen. The octane quality of the adsorber treated product also suffers because desired hydrocarbons in the adsorbent pores have a higher octane number than that of the feedstock.

New insights are required to meet the sulfur levels in motor gasoline desired by the automobile manufacturers, namely, gasoline with no greater than 5 ppm by weight sulfur content. Improved treatments of olefinic feedstocks are required because FCC processes are becoming increasingly significant. Many FCC feedstocks are not hydrogenated. Most of the existing facilities in U.S. refineries are presently incapable of meeting stringent standards for motor vehicle sulfur removal that will become effective in the near future. Furthermore, other olefinic gasoline components, such as visbreaker gasoline or pyrolysis gasoline in refineries abroad, in addition to coker naphtha feedstreams that are prevalent in U.S. refineries, may in combination with FCC components account for as much as 65 percent by liquid volume of the motor gasoline pool in a given refinery.

### SUMMARY OF THE INVENTION

The present invention overcomes the problems that are outlined above and advances the art by providing improved method and apparatus, also using continuous adsorption, to improve process efficiencies in the removal of impurities from liquid flow streams. These advances in adsorption art pertain to increased the yield of adsorption treated product; improved quality in the treated product, and reduction of the utilities that are required to process a given liquid flow stream through use of superior regeneration processes and apparatus. Additional advantages include extending process utility to a wide variety of liquid feedstream other than hydrocarbons that were not amenable to prior processes.

For hydrocarbon feedstocks, the process offers reactivating gas source flexibility and/or reducing significantly the required hydrogen use or reactivating gas for treating a given hydrocarbon feedstock. Significantly, the concepts disclosed herein afford substantial independence from other downstream refinery processing because of reduction in volume of the heteroatom concentrate.

The instrumentalities disclosed herein pertain to method and apparatus for use in treating a liquid stream to remove impurities, where the impurities have a greater affinity for porous adsorbent particulates than do other components of the liquid. For example, a liquid flow stream passes upwardly through a first upright adsorber vessel that contains the porous adsorbent particulates. The flow rate is sufficient to establish fluidized bed performance between the porous adsorbent particulates and the liquid stream.

For hydrocarbon feedstocks, the original fresh porous adsorbent particles comprise a narrow size range, such as 16 by 20 Tyler mesh, 20 by 24 Tyler mesh, and 24 by 28 Tyler mesh, within a preferred range of 16 to 45 Tyler mesh spherical solids range. Design of the fluidized bed under flow conditions that are anticipated in the intended environment of use permits fluidized bed expansion that is normally less than 10%. These design concepts prevent significant top to bottom mixing of the solids where the adsorbent bed is continuously replenished in each stage by entry of adsorbent at the top of the bed while withdrawal occurs from the bottom of the bed. Liquid phase fluidization is extremely smooth through the suggested bed expansion range.

The liquid flow stream in the adsorber vessel contacts the porous adsorbent particulates with sufficient overall residence time for impurity adsorbance to remove impurities in the liquid stream to produce both a purified liquid stream having a reduced impurity concentration and an impurity-bound adsorbent. The purified liquid stream is generally discharged from the terminal stage of the adsorber vessel as a treated product with excellent characteristics. For example, with FCC gasoline feedstocks, the adsorber treated product may be expected to be clear, colorless, free from objectionable odors, free from corrosive compounds such as mercaptans, and generally improved in octane quality. A variety of feedstocks including coker naphtha with significant nitrogen, which were taken from actual refineries and processed through a pilot facility, had nitrogen contents for the adsorber treated product below 0.3 ppm. These advantages, in combination with subsequent sulfur removal, are useful in preparing feeds for downstream processing that economically benefits from such characteristics.

The impurity-bound adsorbent is withdrawn in a slurry from the first upright adsorber vessel and processed, e.g., by thermal processing, to regenerate the adsorbent for recycling purposes. The regenerated adsorbent is recycled through the adsorber vessel.

The first upright adsorber vessel is optionally but preferably constructed in a plurality of sequential adsorption stages in descending order from a terminal adsorption stage to a feed entry adsorption stage. Each of the adsorption stages is separated from the next descending adsorption stage by a flow distributor that permits upward flow of the liquid stream. The openings of the flow distributor are sized such that, when flow is stopped, the settled solids are prevented from proceeding to the next lower adsorption stager except through a transferal line that interconnects the respective stages. In this manner, the regenerated adsorbent first contacts the fluid having the lowest concentration of impurities and the heteroatoms accumulate.

The adsorbent that is withdrawn from the feed entry stage not only has fresh feed liquid filling the spaces between the adsorbent particles, but the porous adsorbent particles are filled with liquid. The slurry solids are separated from the liquids, for example, by a solid-liquid by a separator located atop the regenerator. Thus, the porous particles, free of most of the liquid form interparticle voids, are then subjected to regeneration. Part of the separated liquid may optionally be used, as needed, to decrease the density of the slurry in transit to the regenerator section, and the excess liquid is returned to the adsorber.

The porous solids withdrawn from the feed entry stage of the adsorber vessel have adsorbed liquids from the fresh feed liquid entering the adsorber vessel because the porous solids in an adequately regenerated slurry are introduced to the terminal adsorption stage and descend the full length of the adsorber vessel in contra-flow direction with respect to the flow of hydrocarbon liquid. The fresh feed liquid occupies interstices of the adsorbent particles, and impurities are more strongly attracted for adherence to the surface of the adsorbent particles than are the desired components of the treated liquid product. The term “impurity-bound adsorbent” is hereinafter used to describe this condition. For hydrocarbon feeds containing olefins, such as FCC gasoline feedstocks, olefins are adsorbed preferentially compared to the saturate present, and aromatics are preferentially adsorbed compared to the olefins. Thus, the process facilitates recovering a significant portion of the desired liquid with the higher octane components, which are processed in the regenerator vessel and recycled to the latter adsorber stages become part of the adsorber-treated product.

These purposes are enhanced by creating flow conditions such that flow of the adsorbent particulates in each stage of the adsorber vessel is essentially plug flow in a fluidized bed state to minimize top to bottom mixing of the particulates. Each of the adsorption stages is configured for fluidized bed performance with less than about ten percent bed expansion in the respective fluidized beds within each adsorption stage. Accordingly, the porous adsorbent particulates flow through the first upright adsorber vessel downwardly in contra-direction to the liquid stream under conditions of the fluidized bed performance. The impurity-bound adsorbent is withdrawn from a bottom portion of each adsorption stage except for the feed entry adsorption stage and introduced into the next adsorption stage in descending vertical order. Adsorbent slurry from the fresh feed entry stage is similarly withdrawn and shipped to the regenerator vessel.

A nuclear density device in each of the adsorption stages is used to sense an upper level of the fluidized bed in each of the adsorption stage. A controller uses signals from the nuclear density device to control the position of the upper level by the action of flow valves to withdraw the impurity-bound adsorbent from each of the adsorption stages.

The regenerator vessel has at least a first desorption zone, a second desorption zone, and a cool-down zone. Recirculated gas normally is used in the first desorption zone and is normally heated to about 400° F. for hydrocarbon feedstocks. This gas heats the solids while continuously volatilizing and desorbing a majority portion of the desired liquid product from pores of the absorbent solids entering the regenerator vessel to produce effluent vapor. The effluent vapor from the first desorption zone is cooled to produce condensed liquid and the recycled gas. The temperature at the outlet of the first adsorption zone is controlled for an economic level of impurities in the condensed liquid, such as approximately one-third of the sulfur concentration that is present in the fresh feed.

Solids leaving the first desorption zone are further heated using once through gas heated to about 600° F. to remove bound impurities and produce a substantially regenerated adsorbent. Effluent from the second desorption zone contains the impurities. The regenerated solids leaving the regenerator vessel are cooled in a cool-down zone for subsequent use in the adsorber vessel.

Production of the recycled liquid to the adsorber may be performed in more than one desorption zone if larger production scale units justify or require the capacity. It is preferred that gas flow to the final desorption zone to produce suitably regenerated particulate solids, which is readily permitted by the instrumentalities described herein. In the case of a regenerated solid adsorbent, this is preferably but optionally wetted prior to recycling through the adsorber vessel, in order to prevent the resultant heat of wetting from raising the temperature in the terminal stage adsorber vessel. In this case, the adsorbent or the adsorbent slurry may be cooled sufficiently to overcome heat evolved from wetting the dried form of regenerated adsorbent.

A compatible small guard bed may be used to prevent non-regenerable poisons from entering with the fresh feed. A selective silicon adsorbing bed, for example, may be used to remove silicon from other naphtha feedstocks, and this concept has been successfully tested in a pilot plant.

The liquid feedstream, at least for hydrocarbon feedstreams, is preferred to have approximately 98 percent liquid present boiling below 250° C., so that economic pressure levels may be maintained in the regenerator vessel while preventing excessive temperature in the regenerator vessel which could cause coking. Because lower temperatures favor adsorption, it is preferred to maintain the liquid flow stream entering the adsorber vessel at a temperature less than ambient, or more preferably less than 20° C. A lower adsorber temperature affords lower impurities in the treated product for other wise constant conditions. A lower adsorber temperature also affords a lower solid circulation rate entering the regenerator section for regeneration processing for a given low impurity content for otherwise constant conditions.

The adsorber vessel may be simplified varying the volume in the respective adsorber stages. For example, the terminal adsorption stage has a settled bed height less than 30 meters, and the feed entry adsorption stage has a settled bed height less than four meters. This variation in the height of the respective stages is preferred because the adsorbent in descending adsorption stages has an increasingly higher concentration of impurities. The greatest amount of adsorption occurs in the first adsorption stage, which also contains adsorbent with the greatest amount of impurity. Higher stages have relatively lower impurity concentrations in the adsorbent and in the liquid undergoing treatment. It is preferred to limit the settled bed height in a successive adsorption stage to a height that is no more than twice the height of the preceding stage.

Regenerated adsorbent may be periodically withdrawn and screened to remove fines. Discarded screened fines of an intermediate size may be used to filter the liquid fresh feed if the liquid fresh feed contains scale, other possible debris, or non-regenerable poisons.

When these instrumentalities are implemented, impurities may be reduced with lower utility costs to levels that were not practically obtainable in the prior art.

An especially preferred feature of the regenerator vessel is the use of a gas flow distributor or distributors each including a thin cross-flow bed having a thickness less than about 0.5 meters. The adsorbent solids pass downwardly at a gentle rate while being subjected to cross-flow gas heating with hot gas entering the solids after passing through the distributor. Effluent vapors are discharged from the adsorbent, and these vapors are condensed and collected downstream of the regenerator vessel for subsequent use. The distributors retain the solids but permit passage of the hot gasses, as well as subsequent lower temperature gasses that are used to cool the hot solids.

Although admirably suitable for processing olefinic hydrocarbon feedstocks, the method and apparatus according to the principles described herein can be applied to numerous other feed applications, such as chemicals, where a suitable adsorbent has a selective affinity for the impurities and the feedstock has a limited boiling range suitable for regeneration. Impurities from the liquid stream are concentrated according to these principles, and may have an increased commercial value in concentrated form. For example, liquid aqueous feedstreams can be treated to remove hydrocarbon impurities using a selective adsorbent, such as carbon particulates. The cleanup of impurities for the recycled regeneration medium to the cool down zone may also use a carbon adsorbent.

In the case of treating a fluid catalytic cracker (FCC) full boiling range gasoline feedstock, these principles advantageously disclose returning to the fresh feedstream most of the desired hydrocarbon that is taken from the solids entering the regenerator vessel. Olefins are preferentially returned together with a significant amount of aromatics. The impurity byproduct, which is a heteroatom concentrate in the case of hydrocarbon feeds, is reduced to a volume that reflects the adsorbed impurities. The high octane components are adsorbed preferentially over lower octane saturates in the pores of the adsorbent, but these materials are recycled to the liquid stream after regeneration of the adsorbent. Selective removal of these materials is facilitated by the fact that they have a different affinity for the adsorbent than either the low octane components or the impurities. For example, most of the olefins and monoaromatics in the pores are returned from the regenerator to the adsorber vessel to become part of the adsorber treated product. The return of these materials reduces significantly the chemical hydrogen demand if hydrotreating is used for removing the heteroatoms from the heteroatom concentrate.

The treated product according to the instrumentalities disclosed herein is, therefore, higher in quality and yield, for the adsorber treated product when treating FCC gasoline feedstocks to achieve lower sulfur concentrations, such as a 5 ppm by weight concentration of sulfur that is desired by automotive manufacturers.

### BRIEF DESCRIPTION OF THE DRAWINGS

FIG. 1 is a process schematic diagram illustrating method and apparatus for use in an adsorber/regenerator facility according to the principles and instrumentalities described herein;

FIG. 2 is a generalized graph demonstrating principles of fluidized bed operation involving pressure differential and fluid velocity;

FIG. 3 depicts a section of an adsorber vessel implementing the principles disclosed in the context of FIG. 2; and

FIG. 4 is a midsectional view of desorption zones of a regenerator vessel and illustrates how crossflow beds of the desired thickness within the regenerator vessel may be maintained for larger unit throughputs.

### DETAILED DESCRIPTION

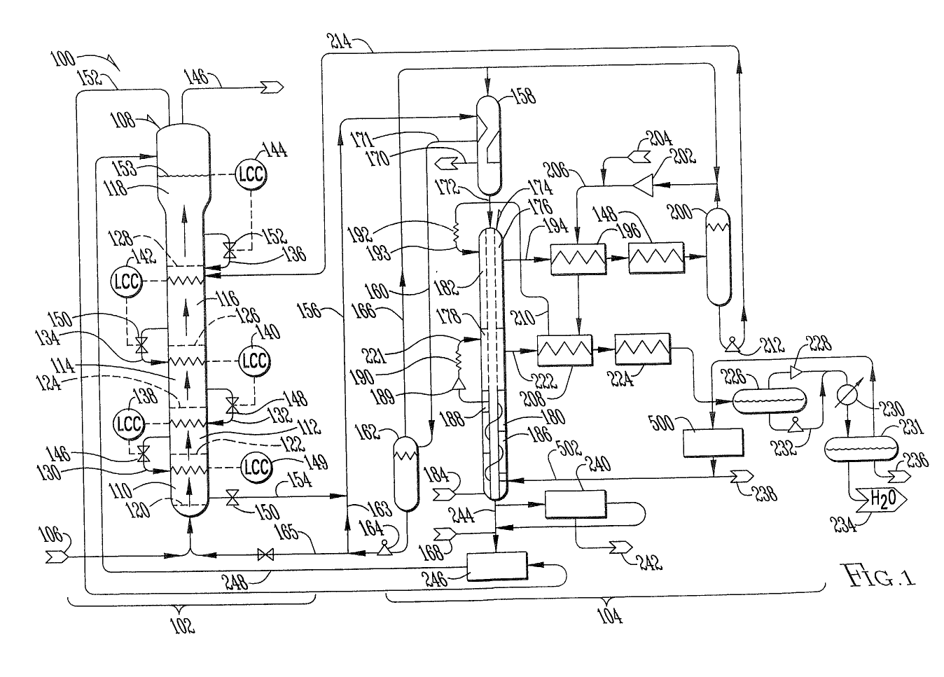

FIG. 1 is a process flow diagram illustrating a facility 100 that contains significant advances in the use of adsorption over the system shown and described in U.S. Pat. No. 5,730,860.

Adsorber Section

An adsorber section 102 is used to remove impurities from liquids where these impurities have a preferential affinity for an adsorbent in respect to the affinity of the other feed components. A regenerator section 104 is used to remove the impurities from the adsorbent and to process the adsorbent for recycling through the adsorber section 102. Feedstreams, other than hydrocarbon liquid feedstreams, may be used, provided that the impurities in the feedstream have a preferential affinity for a solid adsorbent over the desired components. The following is simplified to show, by way of example, the use of a hydrocarbon fresh feed.

A hydrocarbon fresh feed 106, which is suitably cooled and free of agents which might unduly impair the performance of the adsorbent over long term use, enters an adsorber vessel 108 through a fresh feed entry stage 110. The fresh feed entry stage 110 is serially followed by a second adsorption stage 112, a third adsorption stage 114, a fourth adsorption stage 116, and a terminal adsorption stage 118. The precise number of adsorption stages is related to the type of adsorbent that is used, the concentration of impurities in the fresh feed 106, and the objective level of impurity reduction. Each of the adsorption stages 110-118 is a completely filled upright fluidized bed containing hydrocarbon liquid and adsorbent particles. Each of the adsorption stages 110-118 contains a corresponding lower inlet 120, 122, 124, 126, and 128, which each comprise a flow distributor, such as a Johnson-type screen, that permits the passage of liquid and gas while retaining the adsorbent particles. Any number of adsorption stages may be used. The respective adsorption stages may have different settled adsorbent bed thicknesses lengths that, for example, optionally but preferably increase in ascending order. For example, the preferred settled bed height of adsorbent in the feed entry stage 110 is less than four meters. The preferred settled bed height in the terminal adsorption stage 118 is less than 30 meters.

Inter-stage adsorbent transfer lines 130, 132, 134, and 136 permit the downward flow of adsorbent in serial order between the respective adsorbent stages 110-118. Thus, adsorbent in the fourth adsorption stage 116 has a higher concentration of impurities than does the adsorbent in the terminal adsorption stage 118 because the adsorbent in the fourth adsorption stage 116 is transferred from the terminal adsorption stage 118. Similarly, the adsorbent in the third adsorption stage 114 has a higher concentration of impurities than does the adsorbent in the fourth adsorbent stage 116, and the adsorbed impurity concentration increases with descent until the fresh feed adsorption stage 110 has the highest impurity concentration of all. Descending solid adsorbent slurry flow between the adsorption stages 110-118 through the inter-stage transfer lines 130-136 is regulated for each stage by a corresponding solid interface level controller 138, 140, 142, or 144, which governs the opening of a corresponding flow valve 146, 148, 150, or 152, which are preferably pinch valves. This control may be accomplished, for example, by using nuclear density gauges to sense the upper particulate adsorbent levels, such as level 153 in the terminal stage, in each of the fluidized beds within adsorption stages 110-118, and adjusting the opening of flow valve 152 to maintain this interface within a predetermined level for this stage. The pressure differential that is available to overcome distributor bed friction loss and flow valve loss on downflow of the adsorbent is offset by the heavier slurry density of the adsorbent versus the clear liquid in each of the adsorber stages 110-118 above the solid-liquid interface because the fluidized solids behave like heavy liquids in adding hydrostatic head.

Treated hydrocarbon liquid exits the adsorber vessel 108 through line 146, which may, for example, be treated gasoline or a treated feedstock for downstream processing. A final liquid level controller 149 adjusts valve 150 to provide a dense slurry adsorbent withdrawal line 154 that feeds the regeneration section 104 or varies the flow in line 163. A second exit line 151 leaves the terminal adsorption stage 118 to supply fluid for cooling and to assist slurry transport in the regenerator section 104.

The hydrocarbon fresh feed 106 contains impurities having a special affinity for the adsorbent in adsorber vessel 108. For example, the hydrocarbon feed impurities may include heteroatom compounds, such as those containing nitrogen, oxygen and sulfur. Sulfur-containing compounds, include, for example, mercaptans, sulfides, disulfides, thiophenes, and benzothiophenes. Nitrogen containing compounds include, for example, nitrites and pyridines. Oxygen-containing compounds include, for example, peroxides. For hydrocarbon feeds, heteroatom impurities have a polar atom which facilitates preferential adsorption.

For hydrocarbon feedstocks, the adsorbent in each of the adsorbent stages 110-118 is a particulate selective adsorbent, such as alumina containing zeolites. However, any selective adsorbent may be used where the impurities and the desired treated liquid product have different affinites for the adsorbent. For use with dirty feeds, such as coker naphtha feeds, a relatively small guard bed filled with a selective adsorbent may be used to remove the non-regenerable silicon compounds and prevent them from interfering with long term performance of the recirculating adsorbent. This was successfully demonstrated in the original pilot plant. The adsorbent particles are generally spherical and in a suitable narrow range from the 8 to 45 Tyler mesh range. A narrow size range, such as 16×20, 20×24, or 24×28 Tyler mesh is preferred for the original and makeup adsorbent in hydrocarbon feedstock applications.

Liquid phase adsorption differs from gas phase adsorption in that diffusion is at least two orders of magnitude slower in the liquid phase than in the gas phase. Diffusion of components in a liquid phase requires additional residence time. Impurities adsorb on the solid adsorbent because the attraction of the adsorbent surface is stronger than the attractive force that keeps the impurities in the surrounding fluid. Liquid adsorption may be defined as a type of adhesion that, in a thermodynamically preferred sense, occurs at the surface of a solid having an adsorbable impurity in the liquid medium. This preference results in a relatively increased concentration of adsorbable impurities entering the adsorbent particle pores. Solid porous particles can exhibit attraction for impurities for a number of reasons, such as physisorption or chemisorption. Physisorption is due to physical attraction or Van der Waal's forces. Chemisorption is that due to chemical or valence forces.

Adsorption is accompanied by evolution of heat because the adsorbate molecules are stabilized on the adsorbent surface. For limited quantities of impurities in the fresh feed, temperature increase of the fluid is limited by the amount of adsorbable impurities that are typically present, i.e. the sensible heat of the other liquid components offsets the heat evolution due to impurities. Therefore, the temperature rise in the adsorber generally is less than two degrees Fahrenheit for most FCC gasoline feedstocks.

Smaller particulates present additional surface area at the fluid-solid interface for adsorption. If not limited by the process that is used to manufacture the adsorbent, smaller adsorbent particles can advantageously be used in the fluidized adsorbent stages 110-118 that are shown in FIG. 1. This improvement is made possible in fluidized beds because these beds substantially eliminate the pressure drop and crushing concerns that arise when using smaller particles in fixed downflow static bed adsorbers.

Smaller adsorbent particles advantageously enhance the heat transfer and mass transfer for a given gas at otherwise constant conditions. Smaller particles are more difficult to break than larger particles because smaller particles tend to have fewer faults, flaws or discontinuities. Porous particles of a given size are more resilient than non-porous particles of similar size and less prone to fracture.

A disadvantage of smaller particles may be that a smaller cross section flow is required for otherwise constant conditions, such as type of liquid feed, inlet temperature, adsorbent replenishment rate, and liquid feed rate, is required to obtain the same fluidized bed height, which increases the adsorber diameter for a given bed expansion and liquid feed rate under fluidized conditions. This requirement is offset by the fact that a larger diameter provides a larger adsorbent inventory for a given bed height. Higher bed expansions can help offset this disadvantage of smaller particles, but the bed expansion is limited by a need to provide plug flow-like behavior within a fluidized stage. As described below, an undesirable turbulent top to bottom mixing occurs when bed expansions increases sufficiently.

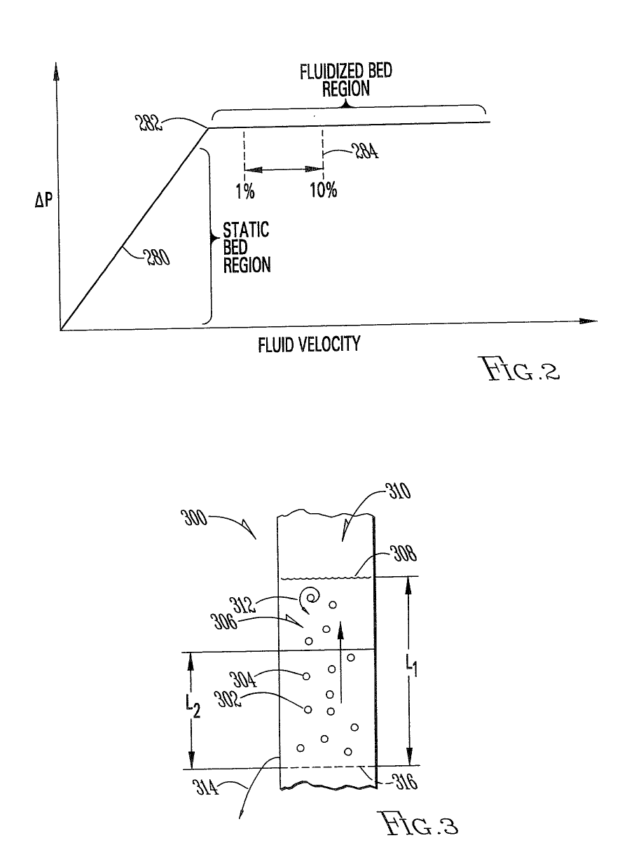

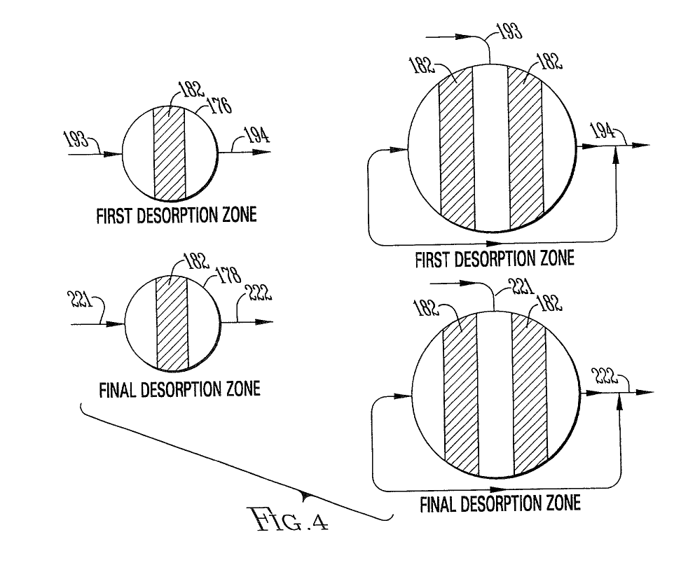

FIG. 2 depicts the principles of fluidized be operation as they pertain to general relationships between fluid velocity and pressure drop across the bed. Pressure drop increases with increasing flow velocity along line 280 until particulates in the bed are being lifted by the flow at a point 282 of minimum fluidization. Pressure drop thereafter over a fluidized bed region of flow is largely constant and only slightly increases with increasing flow velocity. As shown in FIG. 3, stage 300, which represents any one of adsorbent stages 110-118, the adsorbent particulates, e.g., particulates 302 and 304, are suspended in the flow of hydrocarbon liquid 306. The particulates do not rise past an interface 308 defining the upper limit of the fluidized bed along length L₁. Region 310 above interface 308 is a clear liquid. The length L₁ varies depending upon the viscosity of the hydrocarbon liquid 306, the flow rate, the particulate diameter, and the densities of the hydrocarbon liquid and the adsorbent particulates. If flow were to cease or fall below point 282 of minimum fluidization, as shown in Fig,. 2, the particulates 302 and 304 would collapse to a static bed at length L₂. Bed expansion may be calculated by equation (1):

(1) Ε=(L₁−L₂)/L₂

where Ε is bed expansion expressed as a fraction, and L₁ and L₂ are defined above in reference to FIG. 3 as the static (L₁) and fluidized (L₂) bed lengths.

It has been discovered that flow conditions which produce bed expansions ranging from 0.01 to 0.10 (1% to 10%) provide a highly desirable plug flow-like behavior in the fluidized bed because the particles exhibit local circulatory motion in the manner of pattern 312, as opposed to top to bottom mixing in turbulent conditions. After the initial rise of the particles, any introduced particles gradually descend in a local circulatory pattern against the flow towards a bottom discharge 314, which is located at a liquid inlet distributor 316 for removal of particulates. The term “plug flow-like behavior” is not a true unidirectional plug flow, but is used herein to indicate that individual particles tend to migrate upward and downward together as a group that occupies the same level, despite the fact that the flow of liquid proceeds in a uniformly upward direction contrary to the downward flow of particulates. A 1% bed expansion is desired for transport of solids to the withdrawal entrance. More than 10% bed expansion results in top to bottom circulation that is too rapid with resultant lowering of concentration differences and increase of utilities in the regenerator section 104.

One advantage of a fluidized adsorption stage is that a longer bed is unaffected by possible bed crushing strength concerns that, otherwise, arise in context of a downflow fixed bed adsorber. With careful attention of adsorbent addition at the top of a stage and withdrawal at the bottom of a stage, limited bed expansion does not cause undue deviation from plug flow behavior. Solids are withdrawn at the bottom distributor as a dense slurry for transfer to another stage or as spent adsorbent from the feed entry stage. Significantly fewer stages can be used by having the smallest height of bed at the feed entry stage 110 and using greater bed heights for the latter stages 112-118. Lower bed height minimizes the fluidized bed behavior because the impurity concentration difference occurring in a bed decreases. The bed in feed entry stage 110 introduces the fresh feed 106 with the highest impurity concentration in the fluid to contact the adsorbent, which has the highest impurity concentration when withdrawn through line 154 for regeneration.

Reducing the number of fluidized stages in an adsorber vessel of a given height greatly enhances the adsorber inventory that may be stored in a vessel of fixed diameter, as shown in the following Table 1. Such reduction also reduces the costs of associated instrumentation and flow control devices that are required for each stage. For example, the cost of a nuclear density gage, which detects the fluidized solids-liquid interface 308 at the top of a fluidized stage to assist in controlling the bed height within each fluidized stage, is of the order of $15,000. By using longer settled bed height in a stage, more adsorbent inventory can be stored in a given adsorber vessel. Table 1 illustrates the dramatic increase in adsorber efficiency by using greater settled bed heights.

TABLE 1
ILLUSTRATIVE EFFECT OF INCREASED BED HEIGHT UPON
ADSORBER, VOLUMETRIC EFFICIENCY

| Example | Base | A | B | C | D | E | F |
|---|---|---|---|---|---|---|---|
| Settled solid bed height, ft. | 10 | 20 | 30 | 40 | 50 | 60 | 80 |
| Design bed expansion at 10%, ft. | 1 | 2 | 3 | 4 | 5 | 6 | 8 |
| Constant transfer height allowed | 5 | 5 | 5 | 5 | 5 | 5 | 5 |
| above expanded bed, ft. | | | | | | | |
| Overall stage height | 16 | 27 | 38 | 49 | 60 | 71 | 93 |
| Adsorber volumetric efficiency | .625 | .741 | .789 | .808 | .833 | .845 | .860 |

Adsorber volumetric efficiency is defined as the volume of adsorbent in a settled bed divided into the total volume provided for a given adsorber stage. For a cylindrical vessel, assuming constant adsorber diameter, this ratio is equivalent to overall stage height divided into the settled bed height. An expanded diameter, such as at the top of the terminal adsorption stage 118 can increase the adsorber inventory for a given height, accommodate the hydrocarbon recycle liquid entering the stage (e.g., as through line 214), and accept the additional volume of regenerated adsorbent slurry (e.g., through line 151) for transport. Optimum adsorbent size and residence time for a particular adsorbent is a matter for empirical study under actual process conditions

Use of a greater adsorber inventory facilitates correspondingly greater capacity for impurities to deposit on the adsorbent particles.

It is possible to use more than one adsorber vessels in series. For example, the exit line 146, shown in FIG. 1, may be used as a fresh feed source 106 to feed an optional second adsorber vessel (not shown). In this case, liquid from the top of the adsorber vessel 108 reduces the required pumping head.

For otherwise constant conditions, a cooler adsorber vessel 108 results in a lower impurity content in the adsorber treated product. The heat of wetting a dry adsorbent is surprisingly appreciable, and it is preferred to introduce the regenerated adsorbent continuously as a precooled slurry rather than dry solids. Furthermore, the use of liquids for slurrying provides a liquid film that protects the adsorbent particles from mechanical degradation during transport. The use of a cooled slurry facilitates lower impurity content in the treated product by avoiding an increased temperature transient due to the heat evolution from wetting dried adsorbent. A reduction in the amount of solids circulated to the regenerator section 104 is generally obtained, for example, by maintaining the fresh feed 106 at a temperature below ambient, because the lower temperature improves the adsorption capacity of the adsorbent, as well as lowering the sulfur content of the adsorber treated product for other wise constant conditions with a hydrocarbon liquid feedstreams.

Costs to build the adsorption section 102 are generally less than one-third of costs to build the regeneration section 104. Increased adsorbent inventory for otherwise constant conditions, such as use of the same liquid feedstocks, fresh feed rate, adsorber inlet temperature, regeneration conditions, and sulfur content of the treated liquid, in practice increases the impurity concentration deposited on the spent adsorbent that is withdrawn from the feed entry stage 110. The capital cost of the regenerator section 104 is decreased by the instrumentalities disclosed herein because capital requirements are reduced correspondingly with a reduction in the solid circulation rate that must be processed through the regenerator section 104. Operating cost for utilities is primarily associated with the regeneration section 104. The volume of the reactivating gas makeup (184, 204) is related to the solids circulation rate entering the regenerator section 104. The recycled gas used in the first desorption zone and the “once through” preferred heated gas entering the final desorption zone from heater 190 is also related to the solids circulation rate in the regenerator section 100, as well as the recycled gas in the first adsorption zone.

Regenerator Section

As shown in FIG. 1, regenerator section 104 comprises fewer equipment items including heat exchangers and gas compressors, in comparison to the desorber vessel shown in U.S. Pat. No. 5,730,860.

The adsorbent withdrawal line 154 feeds dense adsorber slurry with bound impurities to a dilute slurry transport line 156, which discharges into a liquid-solid separator 158. The liquid-solid separator 158, as shown in FIG. 1, illustrates a plurality of screens that separate the adsorbent particulates from the hydrocarbon feed liquid that fills the void spaces between the solid adsorbent particles. Separated liquids exit the liquid-solid separator 158, via lines 170 and 171, into a drained liquid line 160, which discharges into a liquid surge vessel 162. The liquid filling the innerspaces between the particles is returned to the feed entry stage of the adsorber via line 165.

Part of the liquid from surge vessel 162 may be used as a lift medium via line 163. This lowers the hydrostatic head by lowering the density of the slurry flowing vertically upward through line 156. Pump-assisted line 164 is optionally provided for this purpose so that the vertical lift medium is pumped as a liquid without solids using the liquid both as a diluent and a transport medium. The additional of liquid for use in such transport through line 156 lowers the pumping head required. Liquid minimizes attrition of the solid adsorbent particles because a liquid film cushions the particles from impact with other particles and corresponding mechanical degradation of the solid adsorbent particles. Line 166 is a gas pressure equalization line. A solid adsorbent feed 168 supplies additional adsorbent makeup, as needed.

Liquids leave the solid-liquid separator 158 through lines 170 and 171. Separated adsorbent solids exit the solid-liquid separator 158 through line 172 to enter a regenerator vessel 174, by gravity. The solids therein are subjected to heated cross flow for heating of the descending solids and regeneration of the adsorbent. Regenerator vessel 174 includes a first desorption zone 176, a second or final desorption zone 178, and a cool-down zone 180. A central flow distributor 182 contains openings, such as a Johnson-type screen, that are small enough to retain solids while permitting gas to flow. The solids gradually descend the length of the central flow distributor 182 subject to thermal processing in the form of cross flow heating for desorption purposes, as well as subsequent cooling through a number of cross flow zones.

FIG. 4 provides a midsectional view of the regenerator vessel 174. The central flow distributor 182 should preferably be 0.5 meter in thickness to limit readsorption effects that occur if the bed crossflow path is too long and to limit pressure drop. This may be achieved with multiple crossflow beds in the larger sizes as illustrated by the double sided cross flow beds. The limited thickness of the cross flow beds also acts to decrease the residence time of the solids in the higher temperature portion of the distributor 182 which contains the solids potentially subject to coking temperatures. Smaller particulate adsorbent particles enhance the heat and mass transfer occurring for a given gas at otherwise constant conditions.

A gas source for 184 or 204 is preferably a hydrogen-containing gas source. A plurality of cool-down cross flow stages, such as stages 186 and 188, facilitate a temperature reduction in the regenerated adsorbent that leaves the final desorption zone 178 to below approximately 110° F. The hot gas from cooling zone 180 is compressed by compressor 189 to enter a first heater 190 that supplies gas to the final desorption zone 178. This gas from the cool-down zone 180 is heated, for example, to approximately 30° F. above the temperature of solids leaving the final desorption zone 178. For FCC full boiling range gasoline feedstocks, the temperature entering the first desorption zone 182 is about 400° F. via line 193, and about 600° F., via line 221, to the final desorption zone 178.

As will be explained in more detail below, effluent gas from the final desorption stage 178 preferably provides by heat exchange part of the heat that is required for the recirculated gasses entering the first desorption stage 176. For hydrocarbon feeds, further cooling of the effluent vapor occurs with condensation of the heteroatom condensate forming a liquid that may be separated from the remainder of the effluent vapor. The remaining effluent vapor stream is further compressed, recontacted with the liquid heteroatom concentrate, and subjected to additional separation to condense even more liquid, including water. The gas is preferably passed through an impurity removal device 500 to remove sufficiently any trace impurities from the gas to enter the cool-down zone of regenerator vessel 174 at line 238. Solid bed adsorption, such as using Zeolite as the absorbent in a “lead-lag” arrangement may be used for hydrocarbon service to remove traces in device 500. The absorbent used in device 500 in a similar arrangement may be activated carbon particles if the feedstock is aqueous.

Excess gas above the amount dissolved in the liquid stream products, and that required to fill displaced liquid is vented as gas 239. Gas 239 may be used in commercial practice for part or all of the reactivating gas for device 500 when using an absorbent.

Hydrogen possesses a significantly higher heat conductivity and a lower viscosity than most gaseous fluids at otherwise constant conditions. A hydrogen-containing gas source 204, therefore, is preferably introduced as make-up gas to the first desorber stage 176 at a fraction of the gas quantity that enters the cool-down zone 180. Provision of this hydrogen containing gas to the first adsorber stage 176 assures better heat transfer in desorption zones and sufficient hydrogen to saturate any thermally unstable components which might be formed at higher temperatures.

A gas, free from lighter hydrocarbons and impurities, could be used as gas makeup to 184 below the cool down zone to maintain vapor pressure of the adsorber treated product the same as the entering hydrocarbon feedstream.

The purpose of the first desorption zone 176 is to remove most of the desired hydrocarbon liquids in the pores of the solid adsorbent particulates. Recirculated gas enters the first desorption stage 176 after being heated by the first heater 192 to a temperature of about 400° F. in the case of an FCC full boiling range gasoline feedstock. Actual temperature sufficient to accomplish this purpose depends upon the feed composition and pressure. The effluent containing vaporized liquid from the pores exits through line 194 and is preferably heat exchanged in heat exchanger 196 using compressed recirculated gas from compressor 202. The effluent from heat exchanger 196 is further cooled to preferably below ambient using a cooler 198, and separated in gas-liquid separator 200. The condensed liquid is returned as liquid recycle to the adsorber vessel 108 through pump 212 and line 214 to the latter stages of the adsorber. Gas sources 204 and 184 are a comparatively small makeup gas volume that is only a fraction of that entering the final desorption stage 178, generally less than 0.05.

The composition of fluid condensate evolved after cooling the vapor effluent varies with the temperature of solid adsorbent leaving the first desorber stage 176. The impurity content of the condensate evolved increases with temperature of the solids, but as the hydrocarbon liquid recycle is subject to cleanup in the adsorber vessel 108, is desirable to have about one-third of the impurities removed in the first desorber stage 176. Readily adsorbed components like nitrogen compounds and peroxides in the fresh feed are practically absent, e.g., at concentrations of less than 2 ppm by weight, from the recycle as long as the solid temperature leaving the first desorber stage 176 is less than about 380° F. based upon a full boiling range FCC gasoline feedstock with a nitrogen-compound impurity concentration of 60 ppm. Chilling of the first desorption zone effluent before it enters the gas-liquid separator 200 could be desirable, depending upon the feed, to lower the concentration of any of the more volatile desired components in the recirculated gas. The recirculated gas for the first desorption zone from the gas-liquid separator, as shown in FIG. 1, is compressed for heat exchange and heating sufficiently to heat the descending particles in the first desorption zone to a given temperature. This circumstance affords additional economies by injecting, through use of pump 212 and line 214, the condensed liquid recovered from gas-liquid separator 200 into the latter stages of the adsorber vessel 108 to improve the yield and quality of the adsorber treated product in the case of a FCC gasoline feedstock with modest incremental investment, and with insignificant utility increase.

As described above, desorbed liquid from the regenerator section 104 are concentrated in a liquid recycling system using line 214 to return most of the desired components to the adsorber section 102 where the desired components in the recycled liquid become part of the adsorber treated product. Liquid from the fresh feed fills the spent adsorbent pores with a different composition of which impurity components are only part. In an olefenic fresh feed example, most of the olefins in the spent catalyst pores are returned in the liquid recycle from the first desorption stage to the latter stage of the adsorption section 102. Olefins in the heteroatom concentrate are reduced with subsequent hydrogen consumption advantage, if hydrogenated. For olefinic hydrocarbon feeds, the concentrated impurity liquid has relatively low olefin content as a result of the process shown.

It is also possible, using principally hydrogen for makeup gases to the regenerator, to have the final desorption zone effluent gas 222 containing the heteroatoms directly enter a gas phase reactor for heteroatom conversion by hydrogenation with the heat exchange and cooling occurring after proceeding through the reactor. This requires minimum use of equipment as primarily only a reactor addition is required.

The final desorber stage 178 desorbs higher boiling point aromatics, such as naphthalene, together with the impurities. The final desorber 178 has a solids outlet temperature that is significantly higher than that of the first desorber stage 176. Leaving solids outlet temperature is about 560° F. in the case of a full boiling range FCC feedstock compared to about 370° F. entering the final desorption zone. A greater solids temperature is normally required to liberate the impurities from the adsorbent because some impurities are chemisorbed, as opposed to liberating the pore-bound hydrocarbon liquid in the first desorber zone 176. Effluent vapors from the second desorber zone 178 are transferred through line 222, into the second heat exchanger 208, and into a second cooler 224 that condenses the vapors to a mixed quality liquid-vapor state. The flow discharges into a gas-liquid separator 226 from which a gas output is disposed through compressor 228 to a recontact cooler 230. A heteroatom concentrate is also disposed from gas-liquid separator 226 to the recontact cooler 230 through pump assisted line 232. The gas-liquid separator 231 separates any water for condensed disposal through line 234, heteroatom liquid concentrate through line 236, and gas through line 235. The heteroatom concentrated liquid output through line 236 in the case of FCC gasoline feedstocks is usually disposed of to an existing hydroprocessor for disposal of the heteroatoms, but because of the decreased volume, other disposal techniques such as biological processing are made economically feasible by the instrumentalities described herein.

The gas has impurity traces removed through use of an impurity removal device 500 such as a lead-lag arrangement using a solid adsorber. The recycled gas in the case of a full boiling range FCC feedstock normally supplies approximately 95% of the total gas volume that is needed for use in the final desorption stage 178. The makeup that is required from gas sources 184 and 204 only have to replace losses from leakage, gas that is dissolved in the streams from the regenerator section 104 with sufficient excess for control, and any displacement gas in the solids leaving regenerator section 104. Gas stream 238 supplies most of the gas needed for once through gas entering the final desorption zone 178. The recycling of gas thus permits flexibility to use more economic gas sources for gas source 204. Because only small volumes of gas are required for gas source 204, acceptable gas sources may be from existing facilities having only limited quantities of vented hydrogen below 150 psig that normally vented for fuel use. Examples are the hydrogen-containing vent (not shown) of a once-through isomerization unit, with similar hydrogen chloride removal as for when a small part of the catalytic reformer gas hydrogen byproduct is used for makeup gas. Nitrogen free of impurities could be used as makeup in locations not having hydrogen. The net gas above losses exits via line 239.

The volume of heteroatom concentrate discharged through line 236 is smaller because most of the desired components in the pores become part of the adsorber treated product. The reduced volume and limited olefin content of the concentrated heteroatom liquid that is discharged by line 236 facilitates alternative means of desulfurization, such as biological processing.

A fine removal device 240 is periodically used on long term basis to separate fines from the solid regenerated adsorbent exiting the regenerator vessel 174, such as the screening device 240 to prevent excessive fines in the adsorbent. Periodic screening is performed to remove fines because particles may be expected to attrite in the regenerator section 104 as only a gas separates particles from each other and the wall. Gas velocities are of an order of magnitude higher than when there is liquid present. The fines are disposed through a fine waste line 242. An intermediate size can be used on a long term basis to filter the fresh feed 106 for removal of scale and other possible debris, as well as preventing non-regenerable poisons from contaminating the circulating solid adsorbent. As carbon may gradually build up on the absorbent, stream 241 may be oxidized to bum off the carbon, then screened of fines and added to the system.

Regenerated adsorbent exits the regenerator vessel 174 through line 244 to enter a slurrying station 246. The purpose of slurrying station 246 is to wet the regenerated solids using treated hydrocarbon liquid from the adsorber vessel 108. Line 151 supplies the slurrying station 246 with adsorber treated liquid for this purpose. Slurrying station 246 accomplishes the objective of cooling the slurry including removal of the heat of wetting the dried adsorbent to evolve heat of wetting outside the adsorber vessel 108. The resultant slurry is preferably cooled to slightly below the temperature of fresh feed 106 entering the adsorber vessel 108. Slurry amenable to transportation through line 248 for delivery to the terminal adsorption stage 118. The slurry delivered to the adsorber vessel 108, accordingly, descends through the respective adsorption stages 110-118 in contra-flow direction compared to the ascending flow of fresh feed 106.

Capital investment in the regenerator section 104 is driven by the solid circulation rate entering the regenerator vessel 174. Increasing the adsorber inventory can, therefore, enhance the overall capital investment and is compatible with lower sulfur content transportation fuels desired by automobile manufacturers because of lower capital for the regenerator section 104, particularly with a simplified adsorber and regenerator section, as is illustrated by the attached figures. Operating costs for utilities are primarily associated with the duty on the regenerator section 104.

The foregoing discussion is intended to illustrate the concepts of the invention by way of example with emphasis upon the preferred embodiments and instrumentalities. Accordingly, the disclosed embodiments and instrumentalities are not exhaustive of all options or mannerisms for practicing the disclosed principles of the invention. The inventor hereby states his intention to rely upon the Doctrine of Equivalents in protecting the full scope and spirit of the invention.

I claim:

1. A method of treating a liquid stream which contains impurities in limited amounts with a solid adsorbent having an affinity for the impurities compared with other components in the liquid to reduce the impurities significantly for the adsorber-treated product with the following steps:
providing a liquid fresh feedstream to an adsorber suitably cooled and suitably free from agents which might degrade the impurity removal performance after long term regeneration;
providing a porous, particulate adsorbent within a 8 to 48 Tyler mesh range and in a suitably narrow fraction such that size segregation is acceptable when subject to fluidization with bed expansions no greater than 10 percent with the liquid feedstream or liquid effluent from preceding adsorption stages;
providing an adsorption section consisting of liquid fluidized stages with a bottom inlet and an upper outlet in the adsorber vessel and the same if more than one adsorber vessel;
introducing an adsorbent stream into an upper part of a last adsorption stage to countercurrent contact the said liquid stream that flows upward from a preceding adsorption stage until the said liquid fresh feedstream enters a fresh feed adsorption stage;
withdrawing spent adsorbent as a slurry near an inlet distributor of the fresh feed adsorption stage to proceed to a liquid-solid separator that separates liquid forming the slurry for return as liquid to the adsorption feed stage, whereas the solids separated enter a regeneration section that has at least two desorption zones and a cool-down zone for the regeneration of the spent adsorbent stream;
providing the regeneration section with two or more desorption zones which first continuously desorb a significant portion of the desired liquid product initially in spent adsorbent pores of the adsorbent by recirculating gas after cooling and condensing most of the liquid released, with impurity concentration lower than that of the fresh feed, by stripping and heating with this recirculated gas with suitable makeup gas to a higher temperature than the solids leaving a recycle liquid desorption zone, but significantly lower in temperature than that used for heated gas that enters a final desorption zone and which sufficiently removes the impurities from the solids as a concentrated impurity stream;
introducing desorbed adsorbents from the final desorption zone into the cool-down zone of the regenerator;
introducing a reactivating gas sufficiently free from any agents that might interfere with the desired adsorption of impurities to accomplish cool-down of the absorbent solids leaving the final desorption zone with cross flow contact using a plurality of countercurrent contacts to hot regenerated adsorbent leaving the final impurity stage downwardly flowing for the transfer of heat to the reactivating gas leaving the regeneration section;
causing said heated gas to enter a heater for heating to the required temperature to accomplish sufficiently the desorption of impurities in the final desorption zone on a once through basis;
providing a regenerated adsorbent stream from said cool-down zone with sufficient cooling to remove the heat of wetting, preferably as a slurry with the final desorption liquid before introducing into the adsorber section; and
recirculating the cooled regenerated adsorbent stream for introduction into said adsorption section.

2. The method of treating as set forth in claim 1, wherein 96 weight percent or greater of the particulate adsorbents are in the 14 to 35 Tyler mesh range.

3. The method of treating as set forth in claim 1, wherein the liquid stream comprises a liquid olefinic hydrocarbon feedstream with a limited boiling range approximating less than 250 degrees centigrade for the 98 volume percent point with limited impurities less than approximately 12000 ppmw of sulfur to remove more than 98 weight percent of sulfur entering as feed, and the solids leaving the recycle liquid desorption zone generally are limited to less than 200 degrees centigrade, with the resulting regeneration section condensate containing most of the olefin returned to the adsorption section to become part of the adsorber treated product.

4. The method of treating as set forth in claim 3, wherein any excessive dienes in the recycled liquid condensate from the recycle desorption zone of the regeneration section are hydrogenated selectively with a nickel or palladium containing catalyst, or other suitable catalyst, with limited hydrogen makeup, sufficiently moderate temperatures to avoid green oil formation or saturate olefins, and pressures below 300 psig before entering the adsorption section.

5. The method of treating as set forth in claim 1, wherein the liquid stream is a liquid hydrocarbon feed ranging from 3 to 15 in carbon numbers and the feed entering the adsorption section is not greater than 40 degrees centigrade and preferably below 20 degrees centigrade.

6. The method of treating as set forth in claim 1, wherein the liquid stream is a liquid hydrocarbon feed ranging from 3 to 15 in carbon numbers with a hydrogen containing gas as the reactivating medium makeup and having the vapors leaving the final desorption zone to enter a vapor phase reactor for the hydrogenation of most of the entering heteroatoms with the resulting reactor effluent being condensed with cooling to enter a separator wherein the heteroatom concentrated liquid is further separated.

7. The method of treating as set forth in claim 6, wherein the gas stream from the separator is treated for heteroatom removal and recycled as part of the reactivating gas to the cool down zone of the regenerator.

8. The method of treating as set forth in claim 6, wherein a limited amount of liquid is recycled from the regeneration section is generally less than 4 percent of the hydrocarbon fresh feed supplied to the adsorption section, and is stripped of light ends to fashion the mono aromatic concentrate normally boiling up to approximately 190 degrees centigrade separated as gasoline with possible recycle to the latter stages of the adsorption section for more complete sulfur removal.

9. The method of treating as set forth in claim 6, wherein most higher boiling residuals selected from the group consisting of naphthalene, unhydrogenated benzothiophenes, and quinoline are separated by distillation with possible routing to a higher pressure hydrogenation unit such as a diesel hydrotreater.

10. The method of treating as set forth in claim 1, wherein the liquid stream is a hydrocarbon feed and the condensed liquid from the recycle liquid desorption zone is injected into the latter stages of the adsorption section.

11. The method of treating as set forth in claim 10, wherein the condensed liquid from the recycle zone is subjected to diene removal prior to being injected into the latter stages of the adsorption section.

12. The method of treating as set forth in claim 1, where the liquid stream is a hydrocarbon feed ranging from 3 to 15 in carbon numbers with the effluent vapors from the final desorption zone of the regeneration section being heat exchanged and cooled to produce a concentrated heteroatom liquid that may be biologically desulfurized or hydrogenated.

13. The method of treating as set forth in claim 1, wherein the adsorbent particles are spherical with the original adsorbent and makeup being predominantly greater than 10 Tyler mesh and less than 45 Tyler mesh, but with a particle diameter range of 1.5 for more than 96 percent of the particles.

14. The method of treating as set forth in claim 1, wherein a limited amount of a hydrogen containing gas is used as gas makeup to the first adsorption zone of the regenerator, while nitrogen or other suitable gas is used as the reactivating gas makeup to the cool-down zone of the regenerator.

15. The method of treating as set forth in claim 14, wherein total reactive gas makeup is less the 5% less than the reactive gas make up.

16. The method of treating as set forth in claim 1, wherein the adsorber section comprises a limited number of fluidized stages by limiting the bed expansion in the fluidized zones of the adsorption section with less than seven meter settled bed height in the feed entry stage and less than thirty meter settled bed height in the final adsorption stage.

17. The method of treating as set forth in claim 1, wherein the adsorber section comprises more than one adsorption vessel and the method comprises using part of the liquid adsorption stream from a preceding adsorption vessel closer to the fresh feed as a liquid lift for the withdrawn slurry from the succeeding vessel to reduce the pumping head required for the major part of the liquid adsorption stream that enters as feed to the succeeding vessel.

18. The method of treating as set forth in claim 1, wherein the method further comprises using an enlarged diameter at the top of the adsorber section to facilitate separation of the solids from the liquid while reducing the height for a given bed inventory in the top stage of an adsorption vessel and permitting lift liquid to be used without any increase in superficial velocity for the liquid in the fluidized beds below the enlarged diameter section.

19. The method as set forth in claim 1, wherein the method comprises using a suitable adsorbent vessel as a filtering medium for the fresh feed to ensure removal of scale or other possible debris from dirtier feeds, such as coker or visbreaker distillates, and to preclude nonregenerable poisons such as silicon compounds or iron from contaminating the circulating adsorbent used.

20. The method as set forth in claim 1, wherein the method comprises using screened, smaller diameter adsorbent solids discarded long term from the regenerator as a filtering medium for the fresh feed to be treated to ensure removal of scale and other possible debris or non-regenerable poisons from contaminating the circulating adsorbent used.

21. The method of treating as set forth in claim 1, wherein the liquid stream is a hydrocarbon feed and the method comprises removing corrosive agents such as mercaptans below 0.5 ppmw for the adsorber treated product so that the product passes any copper strip or doctor test.

22. The method of treating as set forth in claim 1, wherein the liquid stream is a dirty, liquid hydrocarbon stream, such as a coker or visbreaker gasoline feedstream, and the method comprises producing a clear water-white product, free from any noxious odors as the adsorber treated product.

23. The method of treating as set forth in claim 1, wherein the liquid stream is a liquid hydrocarbon feed and the method comprises removing nitrogen reduction to less than 0.3 ppmw nitrogen in the adsorber treated product.

24. The method of treating as set forth in claim 1, comprising a step of gravity transfer between stages of the adsorption vessel using a nuclear device for interface fluid level detection for the solids containing bed in a stage and control of the solids transfer by varying the opening in the conduit from the bottom such as with a pinch valve from the bed distributor of the upper stage that contains openings smaller than the fluidized particles which permit liquid effluent from the stage below to enter the succeeding stage.

25. The method of treating as set forth in claim 24, wherein the slurry conduit enters below the near normal expanded solids bed height.

26. The method of treating as set forth in claim 24, wherein the differential for transfer of solids is provided by slurry density in the conduit versus clear liquid density available below the upper stage distributor.

27. The method of treating as set forth in claim 26, wherein the slurry conduit is located outside the adsorption vessel so that external access to the transfer valve is facilitated and interference with even, smooth distribution of the liquid entering the distributor above is minimal.

28. The method of treating as set forth in claim 1, wherein gravity transfers the solids in a continuous manner with a thin, cross-flow bed less than 0.5 meter in thickness for gas cross-flow with suitable baffling on the gas side and with controlled gas flow rates for gas cross-flow in the various zones of the regenerator to minimize the residence of solid particles subject to temperatures that may cause carbonation deposits on the absorbent while avoiding reasorbtion in the desorption zones while avoiding readsorption due to significantly colder temperature of the particles at the gas outlet due to limited cross-flow bed length.

29. The method of treating asset forth in claim 1, wherein liquid feeds to the adsorber are cooled below ambient particularly for low impurity adsorber treated product, such as below 5 ppmw sulfur, while treating any catalytic cracker full boiling range gasoline or derived fractions, pyrolysis gasoline or other olefinic fresh feedstocks.

30. A method of treating a liquid stream to remove impurities, where the impurities have a greater affinity for porous adsorbent particulates than do the components in the liquid, the method comprising the steps of:
flowing the liquid stream upwardly through a first upright adsorber vessel that contains the porous adsorbent particulates at a flow rate sufficient to establish fluidized bed performance between the porous adsorbent particulates and the liquid stream, the porous adsorbent particulates comprised of a 8 to 48 Tyler mesh range with a size distribution that permits bed expansion no greater than 10 percent;
contacting the liquid stream with the porous adsorbent particulates during the flowing step with sufficient residence time for impurity adsorbance that removes impurities in the liquid stream to produce both a purified liquid stream that has a reduced impurity concentration and an impurity-bound adsorbent;
discharging the purified liquid stream from the adsorber vessel; withdrawing the impurity-bound adsorbent in a slurry from the first upright adsorber vessel;
processing the impurity-bound adsorbent after the withdrawing step to remove impurities therefrom and produce a regenerated adsorbent; and recycling at least a portion of the regenerated adsorbent through the adsorber vessel.

31. In a facility for use in removing impurities from a liquid stream by contacting the liquid stream with an adsorbent in an adsorber vessel and removing impurities from the adsorbent by the action of a regenerator vessel precedent to recycling of the adsorbent through the adsorber vessel, the improvement comprising:
the adsorber vessel containing porous adsorbent particulates comprised of a 8 to 48 Tyler mesh range with a size distribution and configured for establishing fluidized bed performance with bed expansion no greater than 10 percent.
